(19) United States
(12) Patent Application Publication
(10) Pub. No.: US 2019/0030852 A1
(43) Pub. Date: Jan. 31, 2019

(54) Microgroove Structure For Controlling Frost Nucleation and Manufacturing Method Thereof

(71) Applicant: National Chiao Tung University, Hsincu City (TW)

(72) Inventors: Ming-Chang Lu, Taipei City (TW); Ching-Wen Lo, Shuili Township (TW)

(73) Assignee: National Chiao Tung University

(21) Appl. No.: 15/711,716

(22) Filed: Sep. 21, 2017

(30) Foreign Application Priority Data
Jul. 31, 2017 (TW) 106125786

(51) Int. Cl. B32B 3/30

(52) U.S. Cl. CPC B32B 3/30; C09D 5/1681

(57) ABSTRACT

The present disclosure illustrates a microgroove structure for controlling frost nucleation, and the microgroove structure has a substrate which has a non-rough surface. The non-rough surface has one or more microgrooves extending along a first direction. The microgroove structure for controlling frost nucleation has nice anti-icing and deicing performances.

### CROSS-REFERENCE TO RELATED APPLICATION

This application claims priority from Taiwan Application No. 106125786, filed on Jul. 31, 2017, in the Taiwan Intellectual Property Office, the content of which is hereby incorporated by reference in their entirety for all purposes.

### BACKGROUND OF THE INVENTION

### 1. Field of the Invention

The present disclosure relates to a microgroove structure for controlling frost nucleation and its manufacturing method, and in particular, to a microgroove structure having nice anti-icing and deicing performances and its manufacturing method.

### 2. Description of the Related Art

At some place of the earth, the temperature may be several degrees below zero at some time point, so inevitably the icing or frosting phenomenon occurs. The icing or frosting phenomenon may cause damage to public facilities, such as electrical installations, highways and airports, resulting in safety problems or other significant loss. In addition, for a refrigerator or an air conditioner, the frosting phenomenon may cause operation problems of the refrigerator or the air conditioner. In addition, the icing or frosting phenomenon can have a significant impact on plants and agriculture.

In order to avoid the problem of major loss and safety caused by the icing or frosting phenomenon, the prior art controls the icing or frosting phenomenon by various chemical methods, mechanical methods, electrothermal heating methods or coating methods. For example, salt can be sprayed on the snow to control the icing phenomenon, but salt may cause environmental pollution; for ice or frost that has been produced, it can be physically removed, but this may damage the icing or frosting devices or articles; the electrothermal heating method can control the icing or frosting phenomenon, but requires additional energy and needs to set the electrothermal heating equipment; and the coating method is to coat a hydrophobic or superhydrophobic layer on a surface of the article or device to control the icing phenomenon, but this cannot control the frosting phenomenon.

In the prior art, the hydrophobicity of the surface of the article is changed to control the nucleation of the ice crystals, thereby achieving the effect of controlling the icing position. However, the hydrophilic surface causes an increase in the adhesion between the ice and the solid, resulting in difficulty of removing icing. Moreover, after the frost is formed on the superhydrophobic surface, the superhydrophobic surface will lose the anti-icing characteristic. In addition, US 2008/0317704 A1 discloses a method for arranging the frost crystal lattices, but it does not disclose a method that can simultaneously control the frost locations and have good anti-icing and deicing effects.

### SUMMARY OF THE INVENTION

To solve at least one of the above technical problems, one object of the present disclosure is to provide a microgroove structure for controlling frost nucleation and its manufacturing method. By using the microgroove structure for controlling frost nucleation, the locations of the frost can be controlled, and by designing the microgroove to be V-shaped, the frost lattice arrangement can be further controlled. Therefore, the microgroove structure for controlling frost nucleation has nice anti-icing and deicing performances.

According to at least one object of the present disclosure, a microgroove structure for controlling frost nucleation is provided, which comprises a substrate having a non-rough surface, wherein the non-rough surface has one or more microgrooves extending along a first direction.

Preferably, along a second direction the two adjacent microgrooves have a distance therebetween, wherein the second direction is perpendicular to the first direction.

Preferably, the microgroove is a V-shaped microgroove or a trapezoidal microgroove.

Preferably, a hydrophobic layer is coated on the non-rough surface.

Preferably, the distance is 125 μm, 165 μm or 250 μm.

Preferably, a width of the microgroove is 7 μm.

Preferably, the substrate is a silicon substrate and the hydrophobic layer is a Teflon® (i.e. PTFE) layer.

Preferably, a droplet contact angle of the non-rough surface is about 135 degrees through 145 degrees.

According to at least one object of the present disclosure, a manufacturing method of a microgroove structure for controlling frost nucleation is provided, which comprises steps as follows. Firstly, a substrate having a non-rough surface is provided. Then, at least one microgroove extending along a first direction on the non-rough surface is formed.

Preferably, the step of forming the at least one microgroove extending along the first direction on the non-rough surface comprises steps as follows. A thin film layer is formed on the non-rough surface and a photoresist layer is formed on the thin film layer, wherein the photoresist layer has an opening to expose a portion of the thin film layer, so as to define at least one location of the at least one microgroove. The exposed thin film layer within the opening is removed by using an etching process, so as to expose a portion of the non-rough surface of the substrate. The photoresist layer is removed and the exposed portion of the non-rough surface of the substrate is etched, so as to form the at least one microgroove. The residual thin film layer is removed.

Preferably, the manufacturing method of the microgroove structure for controlling frost nucleation further comprises the step as follows. After the at least one microgroove extending along the first direction is formed on the non-rough surface, a hydrophobic layer is formed to cover the non-rough surface.

Accordingly, compared to the prior art, the microgroove structure for controlling frost nucleation provided by the embodiment of the present disclosure has benefits as follows.

(1) The frost can be controlled to locate within the microgrooves, and the frost lattice arrangement can be controlled when the microgrooves are designed to be V-shaped.

(2) Nice anti-icing and deicing performances can be achieved.

(3) The anti-icing and deicing effects are achieved without using the chemical method, the mechanical method, the electrothermal heating method and the coating method, thus the property of the environmental protection can be obtained, the extra power consumption and coating are not required, and the substrate itself is not damaged when deicing.

(4) The microgroove structure can be integrated into the air condition system, the refrigerator, the freezing equipment, the aircraft wing, the water cooling fan or the other device or article which needs nice anti-icing and deicing performances.

### BRIEF DESCRIPTION OF THE DRAWINGS

FIG. 1A is a three-dimensional schematic diagram of a microgroove structure for control frost nucleation according to one embodiment of the present disclosure.

FIG. 1B is a schematic diagram showing a sectional view of the microgroove structure of FIG. 1A along the cross-section line AA.

FIG. 2A is a three-dimensional schematic diagram of a microgroove structure for control frost nucleation according to other one embodiment of the present disclosure.

FIG. 2B is a schematic diagram showing a sectional view of the microgroove structure of FIG. 2A along the cross-section line BB.

FIG. 3A is a schematic diagram showing the frost nucleation of the microgroove structures of FIG. 1A and FIG. 2A.

FIG. 3B is a schematic diagram showing the frost nucleation of the microgroove structures of FIG. 1A and FIG. 2A under the view of the electron microscope.

FIG. 4A is a schematic diagram showing the proceedings of the frost nucleation of the several different structures under the view of the electron microscope.

FIG. 4B is a schematic diagram showing the anti-icing proceedings of the several different structures under the view of the electron microscope.

FIG. 4C is a schematic diagram showing the deicing proceedings of the several different structures under the view of the electron microscope.

FIG. 5 is a schematic diagram showing a manufacturing method of a microgroove structure for controlling frost nucleation according to one embodiment of the present disclosure.

### DESCRIPTION OF THE EXEMPLARY EMBODIMENTS

The present disclosure will be described in more detail below with reference to the accompanying drawings, in which exemplary embodiments of the present disclosure are shown. It will be understood by those skilled in the art that the described embodiments may be modified in various ways without departing from the spirit or scope of the present disclosure.

In order to clearly describe the present disclosure, portions not related to the present description are omitted, and like reference numerals refer to like elements throughout the specification. In addition, the dimensions and thicknesses of the individual structural members shown in the drawings are illustrative for convenience of illustration, and the present disclosure is not limited to the illustrated drawings.

An embodiment of the present disclosure provides a microgroove structure for controlling frost nucleation and its manufacturing method. By using the microgroove structure for controlling frost nucleation, the frost can be controlled to form within the microgrooves. Therefore, the microgroove structure for controlling frost nucleation has nice anti-icing and deicing performances. Furthermore, even if the non-rough surface of the microgroove structure can be coated with a hydrophobic layer thereon, the formed frost can be still controlled to locate within the microgrooves. In one embodiment, when the microgrooves are designed to be V-shaped, the frost lattice arrangement within the microgroove can be efficiently controlled, so as to enhance the anti-icing and deicing effects.

The microgroove structure and its manufacturing method provided by the embodiments of the present disclosure are simple and implemented easily, and the microgroove structure by the embodiment of the present disclosure can be easily integrated into the device or article which needs nice anti-icing and deicing performances, for example, the air condition system, the refrigerator, the freezing equipment, the aircraft wing or the water cooling fan. Therefore, the microgroove structure for controlling frost nucleation and its manufacturing method provided by the embodiments of the present disclosure can have industry utilization and huge commercial interests.

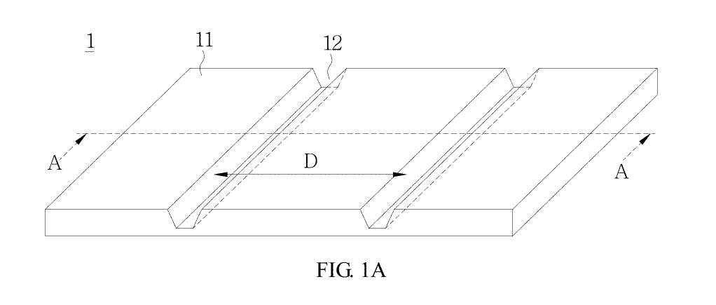

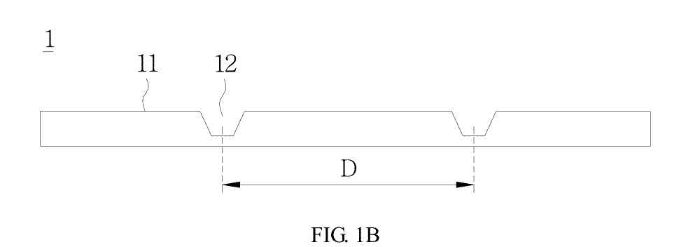

Firstly, refer to FIG. 1A and FIG. 1B. FIG. 1A is a three-dimensional schematic diagram of a microgroove structure for control frost nucleation according to one embodiment of the present disclosure, and FIG. 1B is a schematic diagram showing a sectional view of the microgroove structure of FIG. 1A along the cross-section line AA. The microgroove structure 1 for controlling frost nucleation comprises a substrate 11. The substrate 11 has a non-rough surface which has one or more microgrooves 12 extending along a first direction. The non-rough surface means a smooth surface without holes and protrusions, and thus substrate 11 can for example be a silicon substrate, a metal substrate or a plastic substrate.

The adjacent two microgrooves 12 have a distance D along the second direction, wherein the second direction is perpendicular to the first direction. In this embodiment, the non-rough surface of the substrate 11 may be regarded as an XY plane, and the first direction and the second direction may be the Y-axis direction and the X-axis direction, respectively. The shape of the microgroove 12 is, in this embodiment, a trapezoidal microgroove, but its shape is not intended to limit the present disclosure. The width of the microgroove 12 is the baseline length of the trapezoid, for example, preferably 7 μm. The distance D may be 125 μm, 165 μm or 250 μm, preferably 250 μm, and the present disclosure is not so limited.

In addition, the non-rough surface of the substrate 11 can be coated with a hydrophobic layer thereon (p.s. the hydrophobic layer is not shown in FIG. 1A and FIG. 1B), such as a Teflon® layer. However, the present disclosure does not limit whether or not the non-rough surface of the substrate 11 is coated with the hydrophobic layer thereon. When the hydrophobic layer is coated, if a water droplet is disposed within the microgroove 12 of the non-rough surface of the substrate 11, the droplet contact angle is about 135 degrees to 145 degrees, for example, 140 degrees. The definition of the droplet contact angle described above is the same as that of the droplet contact angle in prior art, and refers to the tangential angle of the water droplet to the non-rough surface.

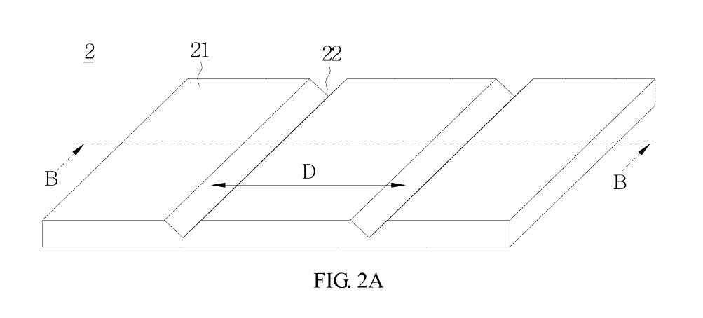

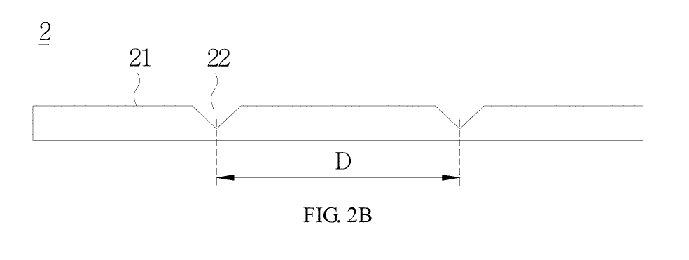

Refer to FIG. 2A and FIG. 2B. FIG. 2A is a three-dimensional schematic diagram of a microgroove structure for control frost nucleation according to other one embodiment of the present disclosure, and FIG. 2B is a schematic diagram showing a sectional view of the microgroove structure of FIG. 2A along the cross-section line BB. The microgroove structure 2 for controlling the frost nucleation comprises a substrate 11. The substrate 21 has a non-rough surface, wherein the non-rough surface has one or more microgrooves 22 extending along a first direction. The microgrooves 22 of this embodiment are V-shaped and the width of the microgroove 22 is the distance between the two vertices of the V-shaped opening, as compared with the embodiment of FIG. 2A and FIG. 2B. When the hydrophobic layer is coated, if a water droplet is disposed within the microgroove 22 of the non-rough surface of the substrate 21, the droplet contact angle is about 135 degrees to 145 degrees, for example, 140 or 142 degrees.

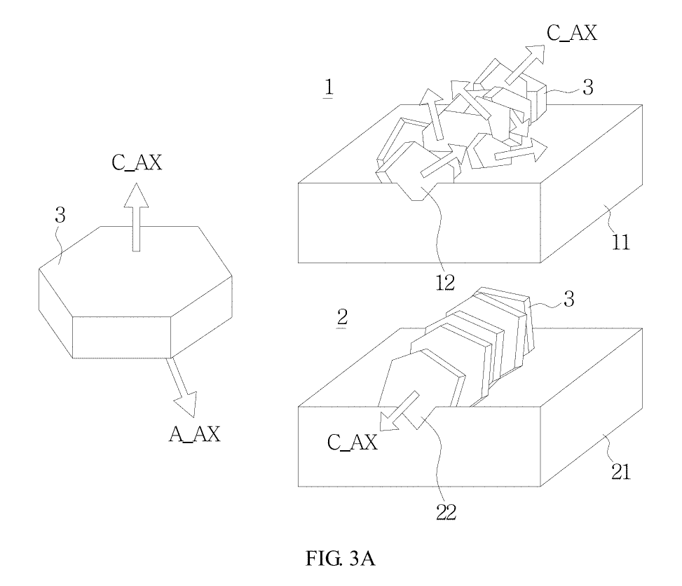

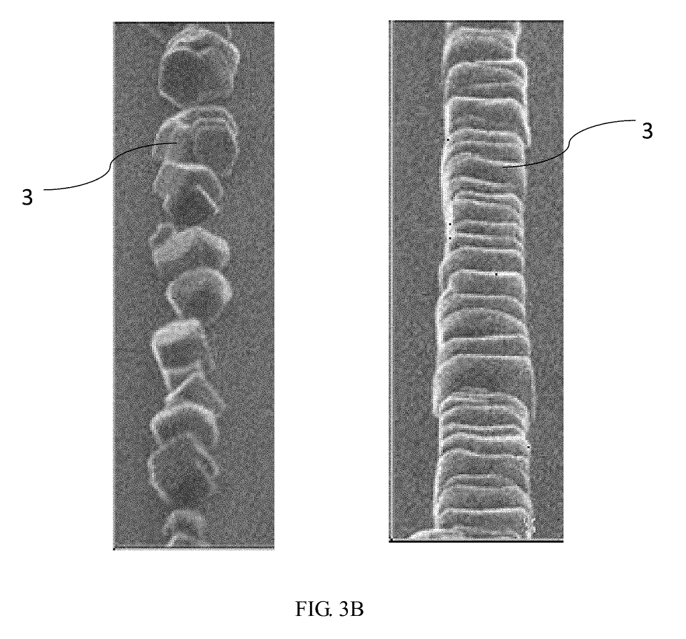

Refer to FIG. 3A. FIG. 3A is a schematic diagram showing the frost nucleation of the microgroove structures of FIG. 1A and FIG. 2A. The crystal lattices of the frost 3 are as shown on the left side of FIG. 3A, which defines a plurality of axes, a first axis C_AX perpendicular to the top facet of the hexagon and second axes A_AX toward outside from the six angles of the side facets of the hexagon. The microgrooves 12 of the microgroove structure 1 of FIG. 1A are trapezoidal and the crystal lattices of the frost 3 are confined in the microgrooves 12, but the lattice arrangement of the frost 3 is scattered and the first axes C_AX of the crystal lattices of the frost 3 do not point to the same direction. The microgrooves 22 of the microgroove structure 2 of FIG. 2A are V-shaped and the crystal lattices of the frost 3 are confined in the microgrooves 22 and the lattice arrangement of the frost 3 is neat and the first axes C_AX of the crystal lattices of the frost 3 substantially point to the same direction, so the anti-icing and deicing performances of the microgroove structure 2 are better than those of the microgroove structure 1.

Refer to FIG. 3B. FIG. 3B is a schematic diagram showing the frost nucleation of the microgroove structures of FIG. 1A and FIG. 2A under the view of the electron microscope. When the temperature in the air drops rapidly, the water vapor will form the frost directly. FIG. 3B shows the case where the frost 3 is preferentially formed in the microgrooves 12 of the microgroove structure 1 of FIG. 1A, and the right side of FIG. 3B is that the frost 3 is preferentially formed in the microgrooves 22 of the microgroove structure 2 of FIG. 2A. It is thus known that the crystal lattice arrangement of the frost 3 in the microgrooves 22 is uniform, and it evidences that when the microgrooves 22 are designed to be V-shaped, the crystal lattice arrangement of the frost 3 can be controlled.

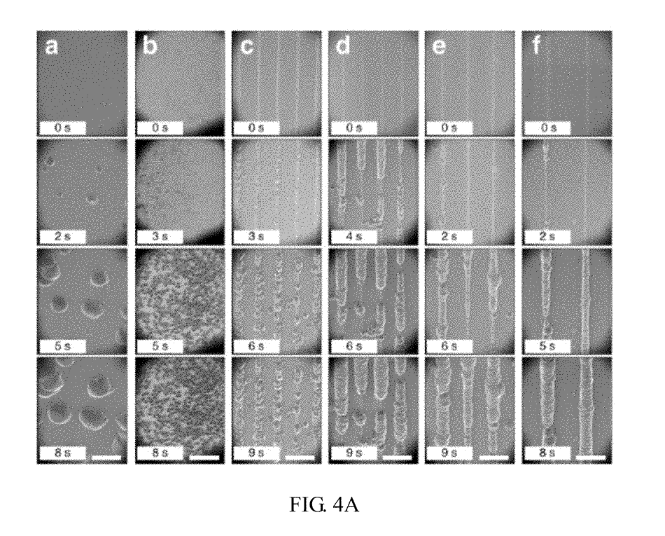

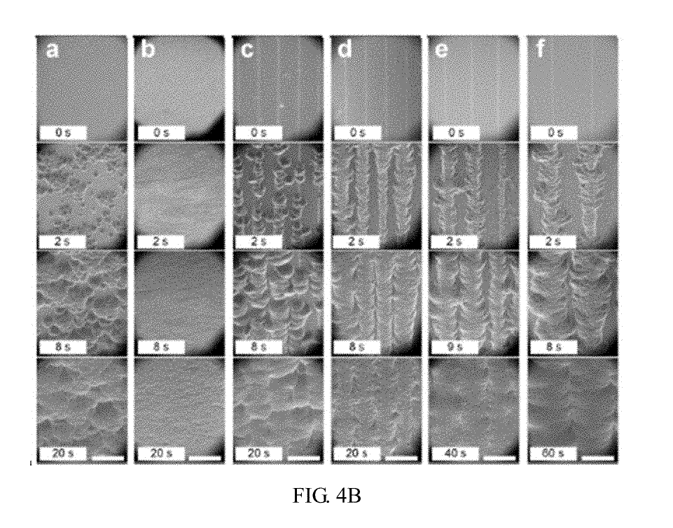

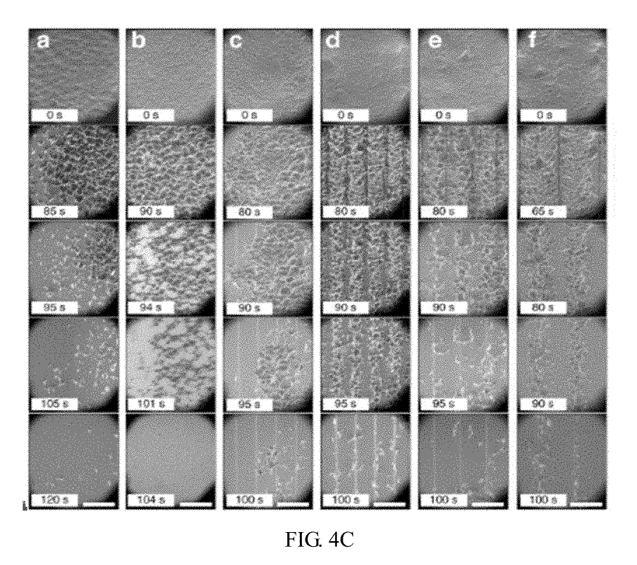

Next, refer to FIG. 4A. FIG. 4A is a schematic diagram showing the proceedings of the frost nucleation of the several different structures under the view of the electron microscope. In FIG. 4A, columns A to F denote the frost nucleation proceedings of a smooth silicon substrate, a silicon nanowire array substrate, a microgroove structure of the first example, a microgroove structure of the second example, a microgroove structure of the third example and a microgroove structure of the fourth example, wherein the lowest white rectangle of each column is a scale whose length represents a length of 20 μm.

The surface of the smooth silicon substrate does not have any micro-grooves, depressions, protrusions and so on; the surface of the silicon nanowire array substrate has an array of holes arranged on the surface; the microgroove structure of the first example is trapezoidal and has a distance of 125 μm; the microgroove structures of the second and fourth examples are V-shaped and respectively have distances of 125 μm, 165 μm and 250 μm.

The surface of smooth silicon substrate, the surface of the silicon nanowire array substrate and the non-rough surfaces of the microgroove structures of the first through fourth examples are coated with the hydrophobic layers thereon, and all of them have droplet contact angles of 100 degrees, 150 degrees, 140 degrees, 140 degrees, 142 degrees and 142 degrees respectively.

In FIG. 4A, the pressure of the ambient scanning electron microscope is gradually increased from 0.6 torr to about a value in the range between 1.2 and 2.1 torr (the corresponding supersaturation is 1.1 to 1.76) with an increment of 0.1 torr per step. In principle, since the nucleation energy barrier of the solid surface is randomly distributed, the nucleation of the frost on a common surface should also be random. The nucleation rate of the frost (J) is inversely proportional to the nucleation energy barrier (AG). Due to the randomness of the roughness of the surfaces of the smooth silicon substrate and the silicon nanowire array substrate, the embryos of the frost are randomly distributed on both surfaces. Compared to the surface of a smooth silicon substrate, a large number of pores on the surface of a silicon nanowire array substrate can substantially increase nucleation density (see column B in FIG. 4A). On the other hand, the microgrooves on the surface of the microgroove structure can locally reduce free nucleation energy barrier and nucleate the frost at the microgrooves (see columns C to F of FIG. 4A). In addition, as shown in column C to column F of FIG. 4A, the nucleation density can be adjusted by changing the number of the microgrooves.

As described above, in columns A and B of FIG. 4A, the frost is randomly nucleated on the surfaces of the smooth silicon substrate and the silicon nanowire array substrate, and respectively in about 8 seconds and 5 seconds, the surfaces of the smooth silicon substrate and the silicon nanowire array substrate are covered with the frost. In column C to column F of FIG. 4A, the frost is controlled to nucleate within the microgrooves, and respectively in at about 9 seconds, 9 seconds, 9 seconds and 8 seconds, only the microgrooves are covered with the frost, but the non-rough surfaces of the substrates are still not covered with the frost. It is known from column C to column F of FIG. 4A that the microgroove structure of the fourth example has better resistance of frost nucleation. Simply put, the V-shaped microgroove with a larger distance design allows the microgroove structure to have better resistance of frost nucleation.

Refer to FIG. 4B. FIG. 4B is a schematic diagram showing the anti-icing proceedings of the several different structures under the view of the electron microscope. In FIG. 4B, columns A to F denote the ice nucleation of a smooth silicon substrate, a silicon nanowire array substrate and microgroove structures of the first through fourth examples, wherein the lowest white rectangle of each column is a scale whose length represents a length of 20 μm.

When the temperature in the air drops non-rapidly, the water droplet will form the ice gradually, and the anti-icing effects of the smooth silicon substrate, the silicon nanowire array substrate and the microgroove structures of the first through fourth examples are shown in FIG. 4B, wherein the surfaces of the smooth silicon substrate and the silicon nanowire array substrate and the non-rough surfaces of the microgroove structures of the first through fourth examples are covered with the ice respectively in about 20 seconds, 2 seconds, 20 seconds, 20 seconds, 40 seconds and 60 seconds. As can be seen from column C to column F of FIG. 4B, the microgroove structure of the fourth example has a better anti-icing effect. Simply put, the design of the V-shaped microgroove with a larger distance allows the microgroove structure to have a better anti-icing effect.

Refer to FIG. 4C. FIG. 4C is a schematic diagram showing the deicing proceedings of the several different structures under the view of the electron microscope. In FIG. 4C, columns A to F denote the deicing proceedings of a smooth silicon substrate, a silicon nanowire array substrate and microgroove structures of the first through fourth examples, wherein the lowest white rectangle of each column is a scale whose length represents a length of 20 μm.

When the temperature in the air rises up non-rapidly, the ice on the surfaces and non-rough surfaces will melt gradually, and the deicing effects of the smooth silicon substrate, the silicon nanowire array substrate and the microgroove structures of the first through fourth examples are shown in FIG. 4C, wherein the ice on the surfaces of the smooth silicon substrate and the silicon nanowire array substrate and the ice on the non-rough surfaces of the microgroove structures of the first through fourth examples melt respectively in about 120 seconds, 104 seconds, 100 seconds, 100 seconds, 100 seconds and 100 seconds. As can be seen from column C to column F of FIG. 4C, the microgroove structure of the fourth example has a better deicing effect. Simply put, the design of the V-shaped microgroove with a larger distance allows the microgroove structure to have a better deicing effect.

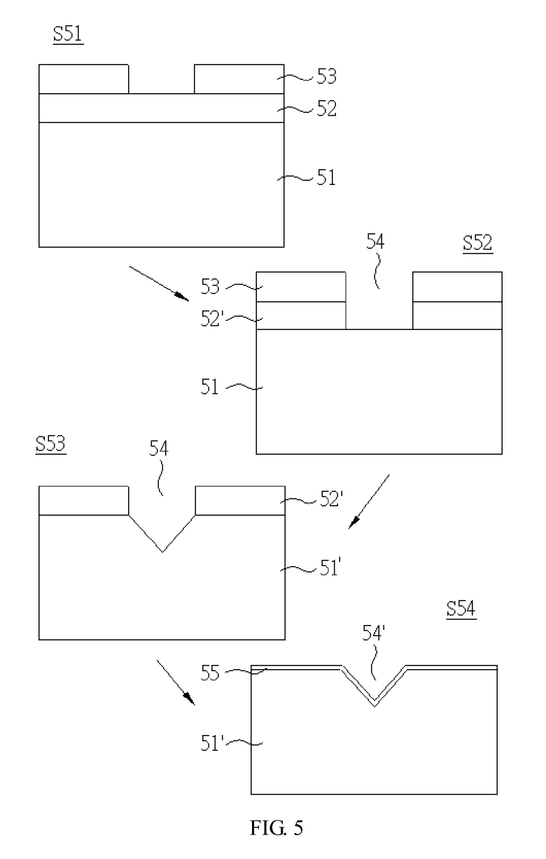

Refer to FIG. 5. FIG. 5 is a schematic diagram showing a manufacturing method of a microgroove structure for controlling frost nucleation according to one embodiment of the present disclosure. First, at step S51, the substrate 51 is provided to form the thin film layer 52 on the non-rough surface of the substrate 51, and the photoresist layer 53 is formed on the thin film layer 52. The portion of the film layer 52 is exposed, thereby defining the position of the microgrooves 54′. The substrate 51 may be a silicon substrate, and the thin film layer 52 may be a silicon nitride layer. At step S51, the thin film layer 52 exposed within the opening is removed by an etching process to expose the portion of the non-rough surface of the substrate 51.

Then, at step S52, the photoresist layer 53 is removed and the portion of the non-rough surface of the substrate 51 exposed to the opening 54 is etched to form the microgroove 54′. Then, at step S53, there is still a residual thin film layer 52′ on the substrate 51′, so that the residual thin film layer 52′ needs to be removed. Finally, at step S54, a hydrophobic layer 55, such as a Teflon® layer, is coated on the non-rough surface of the substrate 51′.

To sum up, the microgroove structure by the embodiment of the present disclosure can control the frost to nucleate within the microgrooves, and when the microgrooves are designed to be V-shaped, the frost lattice arrangement within the microgroove can be efficiently controlled, so as to enhance the anti-icing and deicing effects. The anti-icing and deicing effects are achieved without using the chemical method, the mechanical method, the electrothermal heating method and the coating method, thus the property of the environmental protection can be obtained, the extra power consumption and coating are not required, and the substrate itself is not damaged when deicing. Furthermore, the microgroove structure can be integrated into the air condition system, the refrigerator, the freezing equipment, the aircraft wing, the water cooling fan or the other device or article which needs nice anti-icing and deicing performances.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

1. A microgroove structure for controlling frost nucleation, comprising:
a substrate, having a smooth surface without holes and protrusions, and having one or more microgrooves extending along a first direction on the smooth surface,
wherein along a second direction which is perpendicular to the first direction, the two adjacent microgrooves have a distance therebetween,
wherein the distance is a center-to-center spacing of the two adjacent microgrooves, and the distance is 125 μm, 165 μm or 250 μm,
wherein a width of the microgroove is 7 μm.

2. (canceled)

3. The microgroove structure for controlling frost nucleation according to claim 1, wherein the microgroove is a V-shaped microgroove or a trapezoidal microgroove.

4. The microgroove structure for controlling frost nucleation according to claim 1, wherein a hydrophobic layer is coated on the smooth surface.

5-6. (canceled)

7. The microgroove structure for controlling frost nucleation according to claim 4, wherein the substrate is a silicon substrate and the hydrophobic layer is a PTFE layer.

8. The microgroove structure for controlling frost nucleation according to claim 1, wherein a droplet contact angle of the smooth surface is about 135 degrees through 145 degrees.

9. A manufacturing method of a microgroove structure for controlling frost nucleation, comprising:
providing a substrate having a smooth surface without holes and protrusions; and
forming at least one microgroove extending along a first direction on the smooth surface,
wherein along a second direction which is perpendicular to the first direction, the two adjacent microgrooves have a distance therebetween,
wherein the distance is a center-to-center spacing of the two adjacent microgrooves, and the distance is 125 μm, 165 μm or 250 μm,
wherein a width of the microgroove is 7 μm.

10. The manufacturing method of the microgroove structure for controlling frost nucleation according to claim 9, wherein the step of forming the at least one microgroove extending along the first direction on the smooth surface comprises:
forming a thin film layer on the smooth surface and forming a photoresist layer on the thin film layer, wherein the photoresist layer has an opening to expose a portion of the thin film layer, so as to define at least one location of the at least one microgroove;
removing the exposed thin film layer within the opening by using an etching process, so as to expose a portion of the smooth surface of the substrate;
removing the photoresist layer and etching the exposed portion of the smooth surface of the substrate, so as to form the at least one microgroove; and
removing the residual thin film layer.

11. The manufacturing method of the microgroove structure for controlling frost nucleation according to claim 9, further comprising:
after the at least one microgroove extending along the first direction is formed on the smooth surface, forming a hydrophobic layer to cover the smooth non rough surface.

12. (canceled)

13. The manufacturing method of the microgroove structure for controlling frost nucleation according to claim 9, wherein the microgroove is a V-shaped microgroove or a trapezoidal microgroove.

14-15. (canceled)

16. The manufacturing method of the microgroove structure for controlling frost nucleation according to claim 11, wherein the substrate is a silicon substrate and the hydrophobic layer is a PTFE layer.

17. The manufacturing method of the microgroove structure for controlling frost nucleation according to claim 9, wherein a droplet contact angle of the smooth surface is about 135 degrees through 145 degrees.
